(19) United States
(12) Patent Application Publication
(10) Pub. No.: US 2006/0284651 A1
(43) Pub. Date: Dec. 21, 2006

(54) Circuit and method of blocking access to a protected device

(75) Inventors: Ghil-geun Oh, Yongin-si (KR); Je-yeul Jang, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/430,967

(22) Filed: May 10, 2006

(30) Foreign Application Priority Data
Jun. 1, 2005 (KR) 10-2005-0046765

(51) Int. Cl. G01N 30/86

(52) U.S. Cl. 327/1

(57) ABSTRACT

Provided are a circuit and method of blocking access to a protected device. The blocking circuit includes a fusing circuit and a comparing circuit. The fusing circuit includes at least two fuses. The comparing circuit receives signals transferred through the respective fuses, which are obtained using resistors, compares the received signals and outputs a signal having a predetermined logic level only when the voltage levels of both the received signals are higher than a threshold level.

This application claims the benefit of priority to Korean Patent Application No. 10-2005-0046765, filed on Jun. 1, 2005, in the Korean Intellectual Property Office, the entire contents of which are incorporated herein by reference.

### BACKGROUND OF THE INVENTION

1. Field of the Invention

Example embodiments of the present invention relate to a circuit, and more particularly, to a circuit and method of reducing and/or blocking access to a protected device.

2. Description of the Related Art

A circuit for protecting and/or preventing data recorded in a device from being read by unauthorized users is used to protect information in a protected device, for example, a nonvolatile memory. To restrict and/or prevent unauthorized users from accessing the device, a method of cutting an e-fuse after the device is tested and/or after information is recorded in the device may be implemented to prevent a signal used for accessing the device from being inputted to the device.

FIG. 1 represents signals required for information protection in a conventional nonvolatile memory. FIG. 2 is a circuit diagram of a circuit 20 for restricting and/or completely blocking access to the nonvolatile memory of FIG. 1. Referring to FIG. 2, power supply voltages VDDIO and VDDF and a ground voltage GND may be applied to the circuit 20 initially, and then an enable signal EN having a logic low level may be applied to the circuit 20. For example, if an access signal ACS is activated to a logic high level, an output signal Y is activated to a logic high level through a fuse 22 and a buffer 24. Accordingly, in a normal state, transistors in an electrostatic discharge circuit 21, a fuse cut control circuit 23 and a circuit 25 receiving the enable signal are deactivated, and when the output signal Y is activated to a high level, the nonvolatile memory may be tested and/or data requiring protection may be written in the nonvolatile memory.

After the test and/or data writing is completed, the fuse 22 may be cut such that the data written in the nonvolatile memory cannot be read. For example, to cut the fuse 22 of the conventional circuit illustrated in FIG. 2, the terminal for the power supply voltage VDDF may be connected to ground and a high voltage may be applied to a terminal through which the access signal ACS is inputted and to the terminal for the power supply voltage VDDIO. Accordingly, the material of the fuse 22 may be melted and/or electro-migrate, thereby cutting the fuse 22. If the fuse 22 of the conventional circuit is completely cut, it is difficult and/or impossible to make the output signal Y high in response to the access signal ACS. Accordingly, an unauthorized user would likely not be able to access protected data of a nonvolatile memory after the fuse 22 is completely cut.

However, if the fuse 22 is only partially cut, an unauthorized user may be able to access the protected data written in a nonvolatile memory. Furthermore, in the conventional circuit 20 of FIG. 2, if an unauthorized user can access the enable signal terminal, he/she may apply an enable signal EN having a logic low level to obtain an output signal Y having a logic high level, which may allow the unauthorized use to access protected data of a nonvolatile memory. Accordingly, there is a relatively high probability of an unauthorized user accessing a nonvolatile memory, which is protected by a conventional circuit 20.

### SUMMARY OF THE INVENTION

An example embodiment of the present invention provides a circuit for blocking access to a protected device even if a fuse is incompletely cut. The circuit may completely block access to the protected device

An example embodiment of the present invention provides a method of restricting and/or preventing an unauthorized user from accessing a protected device after a fuse is cut.

An example embodiment of the present invention provides a circuit for blocking access to a protected device. The circuit may include a fusing circuit and a comparing circuit. The fusing circuit may include at least two fuses, and the comparing circuit may receive signals transferred through the fuses and may generate an activated output signal only when the voltage levels of all the received signals are higher than a threshold voltage level. Resistors corresponding to the fuses may be used to obtain the signals received by the comparing circuit.

According to an example embodiment of the present invention, an access signal inputted to the protected device may be transferred to the comparing circuit through the fuses. The fuses may be cut in order to block access to the protected device.

According to an example embodiment of the present invention, the output signal of a comparing circuit may not be activated when any one of the fuses is completely cut. Further, the output signal of the comparing circuit may not be activated when all the fuses are partially cut.

An example embodiment of the present invention provides a method of blocking access to a protected device. The method may include: cutting at least two fuses; receiving an access signal through one end of the fuses; receiving the signals of the other ends of the fuses using resistors; and activating an output signal only when the voltage levels of the signals received using the resistors are higher than a threshold level.

An example embodiment of the present invention provides a method of blocking access to a protected device. The method may include cutting at least two fuses; detecting a first signal at a contact node between one fuse of the at least two fuses and a first resistor; detecting a second signal at a contact node between another fuse of the at least two fuses and a second resistor; and activating an output signal when the voltage levels of all the detected signals are higher than a threshold voltage level.

### BRIEF DESCRIPTION OF THE DRAWINGS

The above and other features and advantages of the present invention will become more apparent to those of ordinary skill in the art by describing in detail example embodiments of the present invention with reference to the attached drawings, in which:

FIG. 1 illustrates signals required for information protection in a conventional nonvolatile memory;

FIG. 2 is a circuit diagram of a conventional circuit for restricting and/or blocking access to a general nonvolatile memory;

FIG. 3 is a block diagram of a circuit for restricting and/or blocking access to a protected device according to an example embodiment of the present invention;

FIG. 4 is a circuit diagram of a circuit according to an example embodiment of the present invention;

FIG. 5 is a circuit diagram of a comparator of FIG. 4 according to an example embodiment of the present invention;

FIG. 6 is a circuit diagram of a comparator of FIG. 4 according to an example embodiment of the present invention;

FIG. 7 is a flow chart showing a device test/information writing process using an access restricting and/or blocking circuit according to an example embodiment of the present invention; and

FIG. 8 is a flow chart showing a fuse cutting process using the access restricting and/or blocking circuit according to an example embodiment of the present invention.

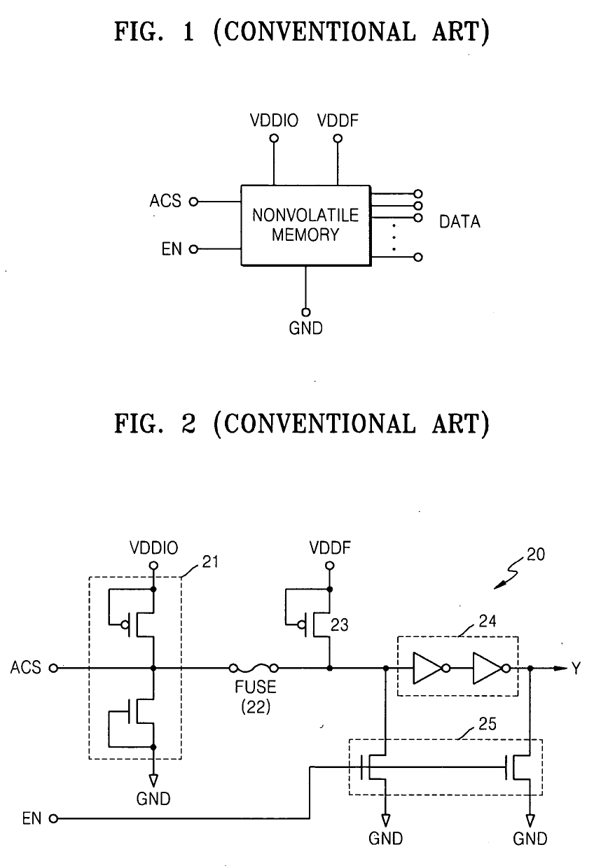

### DETAILED DESCRIPTION OF EXAMPLE EMBODIMENTS OF THE PRESENT INVENTION

Detailed illustrative embodiments of the present invention are disclosed herein. However, specific structural and functional details disclosed herein are merely representative for purposes of describing example embodiments of the present invention. Accordingly, while example embodiments of the invention are capable of various modifications and alternative forms, example embodiments of the present invention are shown by way of example in the drawing. It should be understood, that there is no intent to limit example embodiments of the present invention to the particular forms disclosed in the drawings, but on the contrary, example embodiments of the invention are to cover all modifications, equivalents, and alternatives falling within the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Example embodiments of the present invention will now be described more fully with reference to the accompanying drawings, in which example embodiments of the present invention are shown. The present invention may, however, be embodied in many different forms and should not be construed as being limited to the example embodiments of the present invention set forth herein; rather, these example embodiments of the present invention are provided so that this disclosure will be thorough and complete, and will fully convey the concept of the invention to those skilled in the art. Throughout the drawings, like reference numerals refer to like elements.

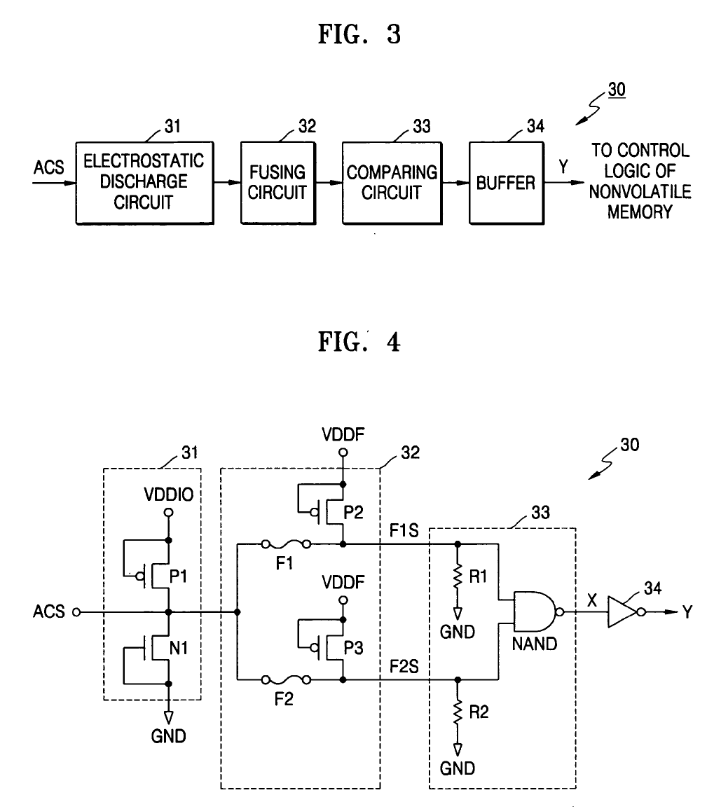

FIG. 3 is a block diagram of a circuit 30 for restricting and/or blocking access to a protected device according to an example embodiment of the present invention.

Referring to FIG. 3, the access blocking circuit 30 may include an electrostatic discharge circuit 31, a fusing circuit 32, a comparing circuit 33, and a buffer 34.

The access blocking circuit 30 may restrict and/or prevent unauthorized users from accessing data written in a nonvolatile memory, for example a flash memory, to protect information stored in the nonvolatile memory.

When a protected device is tested and/or protected data is written therein, the access blocking circuit 30 may receive an access signal ACS activated to a logic high level, and in response, may activate an output signal Y to a logic high level. A control logic of the protected device, which may be a nonvolatile memory, may be operated in response to the output signal Y activated to a high level, and thus a user may access a region of the nonvolatile memory to write data and/or test written data.

When the test of the protected device and/or writing of data in the protected device is completed, fuses included in the fusing circuit 32 may be cut to block access of an unauthorized user. For example, when the fuses F1 and F2 are cut, the output signal Y is maintained at a logic low level even if the access signal ACS is activated to a high level, and thus the control logic of the protected device is not operated. Accordingly, an unauthorized user cannot access the protected data. The fuses included in the fusing circuit 32 may be laser fuses that may be cut by a laser and/or e-fuses that may be electrically cut. The e-fuses may be used due to the convenience of the e-fuses.

A circuit 30 according to an example embodiment of the present invention does not use an enable signal terminal as illustrated in the conventional circuit of FIG. 2. Accordingly, the probability of unauthorized users accessing the protected device may be reduced.

FIG. 4 is a circuit diagram of a circuit 30 according to an example embodiment of the present invention as shown in FIG. 3.

Referring to FIG. 4, an electrostatic discharge circuit 31 may include two MOSFETs P1 and N1. The MOSFETs P1 and N1 may be connected to a common node through which an access signal ACS may be transferred to a fusing circuit 32. For example, a first MOSFET P1 may be a P type MOSFET and may be connected between the common node (ACS terminal) and a first power supply voltage VDDIO. A second MOSFET N1 may be an N type MOSFET and may be connected between the common node and a second power supply voltage GND (ground). A gate and source of the first MOSFET P1 may be connected to each other, and a gate and source of the second MOSFET N1 may be connected to each other for electrostatic discharge.

According to an example embodiment of the present invention, a fusing circuit 32 may include at least two fuses F1 and F2. While FIG. 4 illustrates two fuses F1 and F2, one skilled in the art will appreciate that the number of the fuses is not limited to two. For example, the fusing circuit 32 may include three, four, five, etc. fuses according to example embodiments of the present invention. According to an example embodiment of the present invention, the fusing circuit 32 may also include two P type MOSFETs P2 and P3 used to cut the fuses F1 and F2. A first P type MOSFET P2 of the fusing circuit 32 may be connected between the first fuse F1 and a power supply voltage VDDF. A second P type MOSFET P3 of the fusing circuit 32 may be connected between the second fuse F2 and the power supply voltage VDDF.

A comparing circuit 33 according to an example embodiment of the present invention may include a first resistor R1, a second resistor R2 and a logic gate NAND. The first resistor R1 may be connected to a contact node between the first resistor R1 and the first fuse F1 and to a ground voltage GND, and the second resistor R2 may be connected to a contact node between the second resistor R2 and the second fuse F2 and to the ground voltage GND. The logic gate NAND may have input ports connected to the contact node between the first resistor R1 and the first fuse F1 and the contact node between the second resistor R2 and the second fuse F2. The logic gate NAND may perform a NAND operation on input signals F1S and F2S and may output a resultant signal X. The logic gate NAND activates an output signal X to a logic low level only when both a first voltage level F1S corresponding to the contact node between the resistor R1 and the fuse F1 and a second voltage level F2S corresponding to the contact node between the resistor R2 and fuse F2 are higher than a logic high threshold level.

As described above, the comparing circuit 33 may receive a first signal F1S and a second signal F2S transferred through a first fuse F1 and second fuse F2, respectively. The received first signal F1S and the received second signal F2S may be obtained by the comparing circuit 33 using a first resistor R1 and a second resistor R2 corresponding to the first fuse F1 and the second fuse F2, respectively. Further, the comparing circuit 33 may generate the activated output signal X only when voltage levels of the received first and second signals F1S and F2S are higher than a threshold level.

According to an example embodiment of the present invention, a buffer 34 may invert and buffer the output signal X of the comparing circuit 33 and may output a signal Y. The output signal Y may be output to the predetermined control logic of the protected device, which may be a nonvolatile memory, for example.

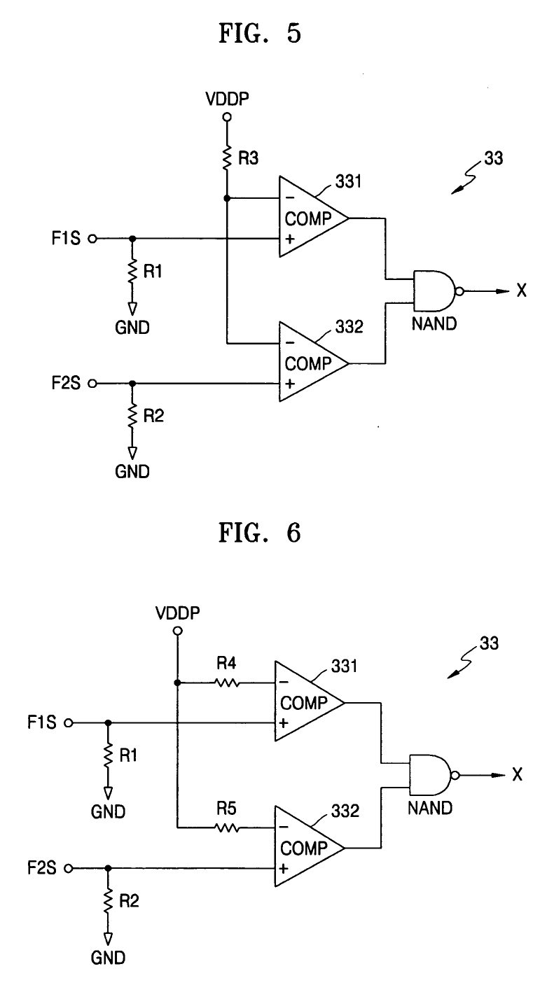

FIG. 5 is a circuit-diagram of a comparing circuit 33 according to an example embodiment of the present invention.

Referring to FIG. 5, the comparing circuit 33 may include a first resistor R1, a second resistor R2, a third resistor R3, a first comparator 331, a second comparator 332, and a logic gate NAND. The first resistor R1 may be connected between the first fuse F1 (shown in FIG. 4) and a first power supply voltage GND and the second resistor R2 may be connected between the second fuse F2 (shown in FIG. 4) and the first power supply voltage GND. One end of the third resistor R3 may be connected to a second power supply voltage VDDP.

The first comparator 331 may have a first input port and a second input port, which may be connected to the contact node of the first resistor R1 and the first fuse F1 and the other end of the third resistor R3, respectively. The second comparator 332 may also have a first input port and a second input port, which may be connected to the contact node of the second resistor R2 and the second fuse F2 and the other end of the third resistor R3, respectively. The first and second comparators 331 and 332 may each output a signal having a high level if the first voltage level F1S and the second voltage level F2S are higher than a voltage level of the contact node of the third resistor R3. Further, the first and second comparators 331 and 332 may each output a signal having a low level if the first voltage level F1S and the second voltage level F2S are lower that the voltage level of the contact node of the third resistor R3. A reference threshold voltage compared to the first voltage level F1S and the second voltage level F2S is determined by the resistance value of the third resistor R3 according to an example embodiment of the present invention illustrated in FIG. 5. The logic gate NAND may have input ports, which may be connected to the output ports of the first and second comparators 331 and 332. The logic gate NAND may perform a NAND operation on signals inputted thereto and may output a resultant signal X.

As described above, the comparing circuit 33 according to an example embodiment of the present invention as shown in FIG. 5 may receive signals F1S and F2S transferred through the fuses F1 and F2 using the resistors R1 and R2, respectively, and may generate the activated output signal X only when the voltage levels of both the input signals F1S and F2S are higher than the threshold level.

FIG. 6 is a circuit diagram of a comparing circuit 33 according to an example embodiment of the present invention.

Referring to FIG. 6, the comparing circuit 33 may include a first resistor R1, a second resistor R2, a fourth resistor R4, a fifth resistor R5, a first comparator 331, a second comparator 332, and a logic gate NAND. The first resistor R1 may be connected between the first fuse F1 (shown in FIG. 4) and a first power supply voltage GND, and the second resistor R2 may be connected between the second fuse F2 (shown in FIG. 4) and the first power supply voltage GND. One end of the fourth resistor R4 may be connected to a second power supply voltage VDDP, and one end of the fifth resistor R5 may be connected to the second power supply voltage VDDP.

The first comparator 331 may have a first input port and second input port, which may be connected to the contact node of the first resistor R1 and the first fuse F1 and the other end of the fourth resistor R4, respectively, as shown in FIG. 6. The second comparator 332 may have a first input port and a second input port, which may be connected to the contact node of the second resistor R2 and the second fuse F2 and the other end of the fifth resistor R5, respectively, as shown in FIG. 6. The first comparator 331 may output a logic high signal if the voltage level F1S is higher than the voltage level of the contact node of the fourth resistor R4 and may output a logic low signal if the voltage level F1S is lower than the voltage level of the contact node of the fourth resistor R4. Similarly, the second comparator 332 may output a logic high signal if the voltage level F2S is higher than the voltage level of the contact node of the fifth resistor R5 and may output a logic low signal if the voltage level F2S is lower than the voltage level of the contact node of the fifth resistor R5. A reference threshold voltage compared to the voltage levels F1S and F2S in the first comparator 331 and the second comparator 332 may be determined by the resistance values of the fourth and fifth resistors R4 and R5, respectively. According to an example embodiment of the present invention, the fourth and fifth resistors R4 and R5 have the same resistance value. However, one skilled in the art will appreciate that the fourth and fifth resistors R4 and R5 may have different resistance values according to an example embodiment of the present invention. The logic gate NAND may have a first input port and a second input port connected to the output ports of the first and second comparators 331 and 332, respectively. The logic gate NAND may perform a NAND operation on signals inputted through the first and second input ports and may output the resultant signal X.

As described above, the comparing circuit 33 according to an example embodiment of the present invention as shown in FIG. 6 may receive signals F1S and F2S transferred through the fuses F1 and F2 using the resistors R1 and R2, respectively, and may generate the activated output signal X only when the voltage levels of both the input signals F1S and F2S are higher than the threshold level.

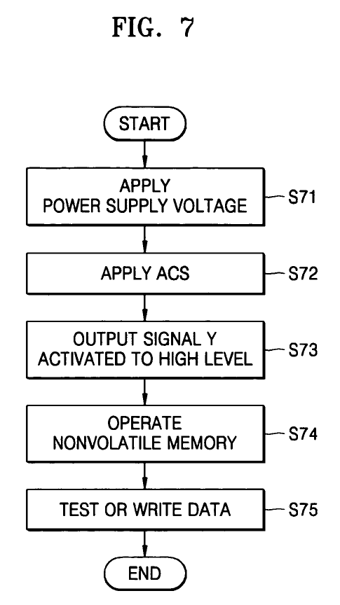

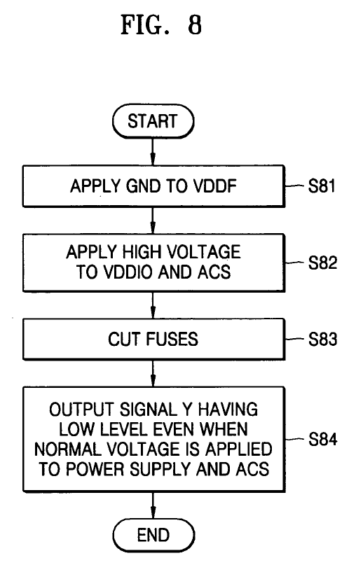

The operation of the circuit 30 according to an example embodiment of the present invention will now be explained in more detail with reference to FIGS. 7 and 8.

FIG. 7 is a flow chart showing a process of testing a protected device and/or writing data in the protected device using an access blocking circuit 30 according to an example embodiment of the present invention.

Referring to FIG. 7, in step S71, power supply voltages VDDIO, VDDF and VDDP and a ground voltage GND may be applied to an access blocking circuit 30 according to an example embodiment of the present invention as shown in FIG. 4 or an access blocking circuit 30 according to an example embodiment of the present invention including the comparing circuit 33 shown in FIG. 5 or FIG. 6. If the access signal ACS is activated to a high level in step S72, the access signal ACS may be transferred to the comparing circuit 33 through the fuses F1 and F2.

In step S73, the NAND gate of the comparing circuit 33 shown in FIG. 4 may output a signal having a logic low level in response to a high level of the access signal ACS transferred to the two input ports to the NAND gate, and thus an output signal Y may be activated to a high level through the buffer 34. If the comparing circuit 33 of FIG. 5 or FIG. 6 is used, the comparators 331 and 332 of the comparing circuit 33 may output signals having a logic high level because the voltage level of the logic high access signal ACS transferred to the positive input ports of the comparators 331 and 332 is higher than the reference threshold level sent to the negative input ports of the comparators 331 and 332. Accordingly, the NAND gate outputs a signal having a logic low level and the buffer 24 activates the output signal Y to a high level in step S73.

In this normal state, the transistors P1, P2, P3 and N1 included in the electrostatic discharge circuit 31 and the fusing circuit 32 are not turned on. For example, the transistors P1 and N1 illustrated in FIG. 4 of the electrostatic discharge circuit 31 are turned on only when high voltage static electricity is introduced into the access signal terminal to prevent the introduction of static electricity, and the transistors P2 and P3 of the fusing circuit 32 are turned on only when the fuses F1 and F2 are cut.

In step S74, if the output signal Y is activated to a high level, the control logic of the protected device, which may be a nonvolatile memory, may be operated. Accordingly, in step S75 a user may access a corresponding region of the nonvolatile memory to write protected data in the nonvolatile memory and/or test data written in the nonvolatile memory.

After the test of the protected device and/or data writing in the protected data is completed, the fuses F1 and F2 may be cut to restrict and/or block access to the protected device and prevent protected data from being read. FIG. 8 is a flow chart showing a process of cutting the fuses using the access blocking circuit 30 according to an embodiment of the present invention. Referring to FIG. 8, in step S81, to cut the fuses F1 and F2, the ground may be connected to the power supply voltage VDDF in the access blocking circuit 30 of FIG. 4 or the access blocking circuit 30 comprising the circuit of FIG. 5 or FIG. 6. A high voltage may be applied to both the access signal terminal and the power supply voltage VDDIO in the step S82. Accordingly, the material of the fuses F1 and F2, preferably, e-fuses, may be melted or electro-migrated to cut the fuses F1 and F2 in the step S83.

After the fuses are cut, even if a power required for operating the access block circuit 30 is supplied to the circuit 30 and even if the access signal ACS is activated to a high level, the output signal Y may be maintained at a logic low level. Accordingly, the predetermined control logic of the protected device is not operated so an unauthorized user cannot access protected data written in the protected device in the step S84.

As described above, an access blocking circuit 30 according to an example embodiment of the present invention as shown in FIG. 4 or an access blocking circuit 30 including the circuit of FIG. 5 or FIG. 6 according to example embodiments of the present invention does not require the enable terminal EN shown in the conventional circuit of FIG. 2. Furthermore, a comparing circuit 33 according to an example embodiment of the present invention does not output a signal activated to a low level when one of the two fuses F1 and F2 is completely cut. Moreover, even if both the two fuses F1 and F2 are only partially cut, the comparing circuit 33 does not output a signal having a low level. Partially cut is used to describe a situation where a fuse serves as a conductor having a large resistance value due to denaturation of the fuse material or partial cutting of the fuse.

According to an example embodiment of the present invention, after the fuses are cut, the comparing circuit 33 may stably output a high level signal and the output signal Y may be maintained at a logic low level even though the access signal ACS may be activated to a high level. For example, even when the first fuse F1 is completely cut but the second fuse F2 is incompletely cut, the comparing circuit 33 outputs a high level signal and the output signal Y is maintained at a low level because, when the access signal ACS is activated to a high level, the voltage distributed to the resistor R2 is small due to a large resistance of the second fuse F2 and a small resistance of the resistor R2. Similarly, for example, when both the first and second fuses F1 and F2 are incompletely cut, the comparing circuit 33 outputs a high level signal and the output signal Y is maintained at a low level because, when the access signal ACS activated to a high level, the voltages distributed to the resistors R1 and R2 are small due to large resistances of the fuses F1 and F2 and small resistances of the resistors R1 and R2.

As described above, in the circuit 30 restricting and/or blocking access to a protected device according to the present invention, the fuse circuit 32 may include at least two fuses F1 and F2 and the comparing circuit 33, may receive signals transferred through the fuses F1 and F2 using the resistors and may compare input signals F1S and F2S to output a signal having an appropriate logic level only when the voltage levels of both the input signals F1S and F2S are higher than the threshold level.

The circuit 30 for restricting and/or blocking access to a protected device according to an example embodiment of the present invention may output a signal having an appropriate level even when a partially cut fuse remains after cutting the fuses. Accordingly, the circuit 30 according to an example embodiment of the present invention may prevent an unauthorized user from easily accessing the protected device such as a nonvolatile memory.

While the present invention has been particularly shown and described with reference to example embodiments of the present invention, it will be understood by those of ordinary skill in the art that various changes in form and/or details may be made therein without departing from the spirit and scope of the present invention.

What is claimed is:

1. A circuit for blocking access to a protected device comprising:
a fusing circuit including at least two fuses; and
a comparing circuit receiving signals transferred through the at least two fuses, and generating an activated output signal when voltage levels of all the received signals are higher than a threshold voltage level.

2. The circuit of claim 1, wherein resistors corresponding to the at least two fuses are used to obtain the signals received by the comparing circuit.

3. The circuit of claim 1, wherein an access signal for the protected device is transferred to the comparing circuit through the at least two fuses.

4. The circuit of claim 1, wherein the at least two fuses are cut to block access to the protected device.

5. The circuit of claim 1, wherein the output signal of the comparing circuit is not activated when any one of the at least two fuses is completely cut.

6. The circuit of claim 1, wherein the output signal of the comparing circuit is not activated when one or more of the at least two fuses are partially cut.

7. The circuit of claim 1, wherein the fusing circuit comprises:
a first fuse;
a second fuse;
a first transistor connected between the first fuse and a power supply voltage; and
a second transistor connected between the second fuse and the power supply voltage.

8. The circuit of claim 7, wherein the first and second transistors are P type MOSFETs.

9. The circuit of claim 1, wherein the at least two fuses are e-fuses.

10. The circuit of claim 1, wherein the fusing circuit includes two fuses, and the comparing circuit comprises:
a first resistor connected between one of the two fuses and a power supply voltage;
a second resistor connected between another fuse of the at least two fuses and the power supply voltage; and
a NAND gate having a first input port connected to a contact node between the first resistor and the one of the two fuses and a second input port connected to a contact node between the second resistor and the another fuse.

11. The circuit of claim 1, wherein the fusing circuit includes first and second fuses, and the comparing circuit comprises:
a first resistor connected between the first fuse and a first power supply voltage;
a second resistor connected between the second fuse and the first power supply voltage;
a third resistor having a first end connected to a second power supply voltage;
a first comparator comparing voltage levels of the input ports to output a logic signal and having a first input port connected to a contact node between the first resistor and the first fuse and a second input port connected to a second end of the third resistor;
a second comparator comparing voltage levels of the input ports to output a logic signal and having a first input port connected to a contact node between the second resistor and the second fuse and a second input port connected a second end of the third resistor; and
a NAND gate having a first input port connected to an output port of the first comparator and a second input port connected to an output port of the second comparator.

12. The circuit of claim 1, wherein the fusing circuit includes first and second fuses, and the comparing circuit comprises:
a first resistor connected between the first fuse and a first power supply voltage;
a second resistor connected between the second fuse and the first power supply voltage;
a third resistor having a first end connected to a second power supply voltage;
a fourth resistor having a first end connected to the second power supply voltage;
a first comparator comparing the voltage levels of input ports to output a logic signal and having a first input port connected to a contact node between the first resistor and the first fuse and a second input port connected to a second end of the third resistor;
a second comparator comparing voltage levels of input ports to output a logic signal and having a first input port connected to a contact node between the second resistor and the second fuse and a second input port connected to a second end of the fourth resistor; and
a NAND gate having a first input port connected to an output port of the first comparator and a second input port connected to an output port of the second comparator.

13. The circuit of claim 1, further comprising:
an electrostatic discharge circuit connected to a node through which a common signal is transferred to the fuses.

14. The circuit of claim 13, wherein the electrostatic discharge circuit comprises:
a first transistor connected between the common signal node and a first power supply voltage; and
a second transistor connected between the common signal node and a second power supply voltage.

15. The circuit of claim 14, wherein the first transistor is a P type MOSFET and the second transistor is an N type MOSFET.

16. The circuit of claim 1, further comprising:
a buffer connected to an output port of the comparing circuit.

17. A method of blocking access to a protected device comprising:
cutting at least two fuses;
detecting a first signal at a contact node between one fuse of the at least two fuses and a first resistor;
detecting a second signal at a contact node between another fuse of the at least two fuses and a second resistor; and
activating an output signal when the voltage levels of all the detected signals are higher than a threshold voltage level.

18. The method of claim 17, wherein the output signal is not activated when any one of the at least two fuses is completely cut.

19. The method of claim 17, wherein the output signal is not activated when one or more of the at least two fuses are incompletely cut.

20. The method of claim 17, wherein a number of the at least two fuses is two.

21. The method of claim 17, further comprising:
discharging static electricity of a node through which a common signal is transferred to the at least two fuses.

22. The method of claim 17, further comprising:
buffering the output signal.

23. The method of claim 17, wherein the at least two fuses are e-fuses.
